(19) United States
(12) Patent Application Publication
(10) Pub. No.: US 2003/0077424 A1
(43) Pub. Date: Apr. 24, 2003

(54) Method and apparatus for creating mosaic structures

(76) Inventor: Mahesh Patel, Forest Hills, NY (US)

Correspondence Address: KATTEN MUCHIN ZAVIS ROSENMAN, 575 MADISON AVENUE, NEW YORK, NY, 10022-2585, US

(21) Appl. No.: 09/982,443

(22) Filed: Oct. 18, 2001

(51) Int. Cl. B32B 23/02

(52) U.S. Cl. 428/192

(57) ABSTRACT

An apparatus and method for creating mosaic structures, generally comprises the steps of providing a frame comprising spaces for individual pieces of a mosaic tile. Each of the individual pieces are spaced from each other and positioned in each space and are circumscribed by a peripheral ridge surrounding each piece.

Grout is poured into the spaces between the pieces. The grout is then permitted to dry and the resulting tile is removed from the frame.

### FIELD OF THE INVENTION

The present invention relates to creating mosaic structures, for instance, mosaic tiles comprised of numerous pieces held together.

### BACKGROUND OF THE INVENTION

Mosaic designs for use in images, walls, tiles, etc., have been known for centuries—indeed millennia. Of particular beauty are the mosaics in the city of Ravenna, Italy, which are known all over the world.

Tiles comprised of pieces of stone, glass or other material are highly desirable for baths and other areas of a home or apartment. Such tiles are typically 12 inches by 12 inches in dimension, with each of the stones being approximately ⅜ of an inch square.

A traditional method of creating such tiles is depicted, for example, in FIG. 1, which shows the steps of providing a netting (FIG. 1a), applying adhesive thereto (FIG. 1b), arranging individual small constituent pieces (“tile pieces”) of the overall tile (FIG. 1c) with the top side up—that is, the side to be viewed (or stepped on if for a floor) is facing up. The pieces are arranged with gaps between successive pieces to create a “mosaic” effect.

Grout is then poured (FIG. 1c) onto the tile pieces and moved (by hand, using a tool or by the flowable nature of the grout if mixed with sufficient liquid) into the gaps between the tile pieces. For the grout between the tile pieces to be relatively level, it must be:

(a) in a sufficiently “runny condition;” or

(b) accurately smoothed by hand or a tool; or

(c) of a sufficient amount that it is fairly level with the top surface of the tile pieces.

Regardless of the above method however, the top surfaces of the tile pieces must be cleaned of the group—a labor intensive task.

The above method of creating mosaic tiles is extremely labor intensive and make the tiles difficult to assemble. Further, when a tile is cut, chipping of the individual stones could occur. Chipping can be a more significant problem with particular types of stones such as slate as sheeted segments of which can easily detach across parallel planes. Angular cutting of the pieces is particularly difficult because the flexible nature of the netting allows the tile pieces to move substantially when subject to vibration or nudging.

An additional problem with the traditional method of creating mosaic tiles is that the top surface of the tile is often uneven, specially when the individual tile pieces are of different heights.

Even placing “spacers” (FIG. 1c) between adjacent pieces to assure uniform spacing between tile pieces can be difficult and labor intensive by the traditional method.

A further problem occurs when using metallic tile pieces because under the traditional method a filled, solid metal piece (which is heavy and costly to produce) must be used in order to lay flat on the netting prior to the pouring of the grout.

A still further problem with the traditional method of laying mosaics is that grooves on adjacent tiles do not line up well—particularly when installing mosaic tiles on walls.

A further problem with the traditional method is that smaller dimensional pieces such as ⅜″ cannot be easily laid as the height may not be sufficient to create significant contract by the grout between such adjacent pieces.

It is therefore a object of the present invention to provide a method and apparatus of creating mosaic structures which is less labor intensive than conventional methods.

Another object of the invention is to provide a method and apparatus for the creation of mosaic structures in which the structures may be more easily cut, without the pieces easily chipping and breaking.

A further object of the invention is to provide a method and apparatus for creating mosaic structures in which the grout lines can be substantially uniform, while lying below the plane of the top surface of the tile pieces and in which corresponding grout lines of adjacent tiles line up.

A yet further object of the invention is to provide a method and apparatus for laying grout in which the top surfaces of the tile pieces are on a substantially flat plane, even if the heights of the tile pieces are quite different.

Additionally, an object of the invention is to provide a method and apparatus for creating mosaic structures in which tile pieces made of stamped metal may be used in place of solid filled metal pieces.

### SUMMARY OF THE INVENTION

These and other aspects of the invention, which shall become apparent hereafter, are achieved by a method and apparatus for creating mosaic works, comprising the steps of providing a template or frame for the positioning of mosaic pieces therein with gaps between adjacent pieces. The gaps are created by the existence a low wall circumscribing each of position for the insertion of each tile piece. The height of the parametric wall does not extend beyond the height of each tile piece.

The tile pieces are positioned into the frame so that the “top” side of the pieces face downward. The next step is optionally applying adhesive onto the tile pieces and then optionally placing a mesh or other securing and flexible mechanism to hold the pieces together. The next step is the pouring of sufficient “grout” or other cement/adhesive—like product onto the bottom side of the pieces so that grout runs into the spaces between the pieces and covers the top planar surfaces of the positional parametric walls. Sufficient grout must be poured so as not only to fill the spaces between individual tile pieces, but also to provide a sufficiently thick grout layer on the tile pieces to hold the pieces together as a single tile once the tile is removed from the template after the drying of the grout.

### BRIEF DESCRIPTION OF THE DRAWINGS

The invention will be better understood by the Detailed Description of the Preferred Embodiment, with reference to the drawing in which:

FIGS. 1(a)-(c) depict a prior art method of creating mosaic structures;

FIG. 2 is a cross sectional view of a tile showing grout between the tile pieces taken across the direction of line 2-2 of FIG. 1-(c);

FIG. 3 is a perspective view of a template containing individual small mosaic pieces within its frame; and

FIG. 4 is a cross sectional view of a stamped metallic tile piece in a position of the template frame.

### DETAILED DESCRIPTION OF THE PREFERRED EMBODIMENT

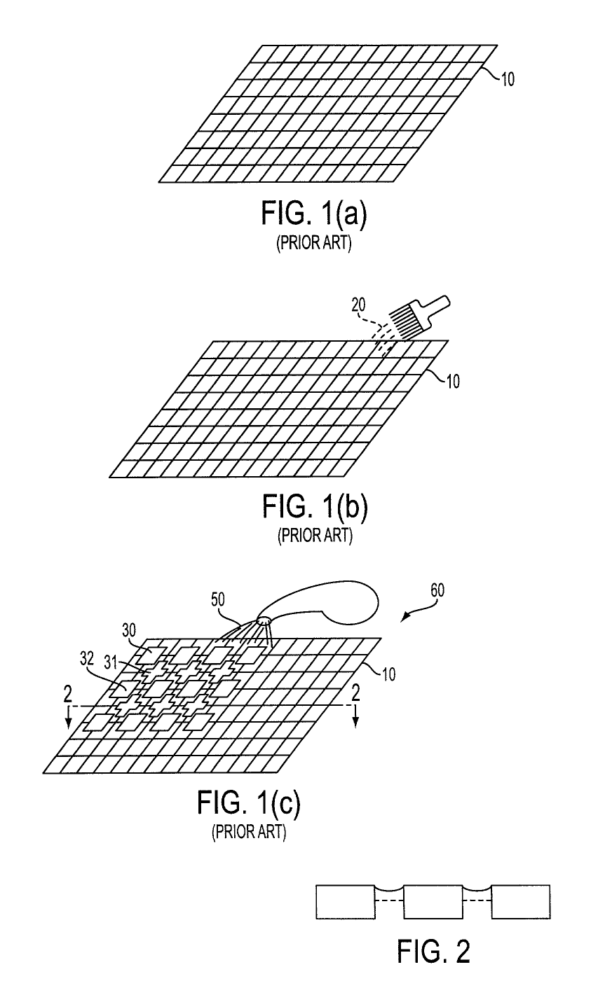

Referring now to the drawings, wherein like numerals reflect like elements throughout the various views, a the traditional method of creating mosaic structures is depicted in FIGS. 1(a)-1(c) and comprises the steps of providing a netting 10, applying an adhesive (see FIG. 1(b)) 20 thereon and positioning tile pieces 30 thereon (see FIG. 1(c)).

In order to obtain uniform spacing between adjacent tile pieces 30 and maintain straight rows and columns, spacers 31 maybe used. Of course, even the positioning of spacers 31 consumes much time. Alternatively, the tile pieces 30 may be painstakingly positioned by “eyeballing” them in an effort to obtain uniform spacing.

Once the adhesive 20 dries and the tile pieces are secured, the next step is the pouring of a second adhesive compound, typically known as “grout” 50 (see FIG. 1(c)), to fill the spaces in the gaps between individual adjacent tile pieces. After pouring the grout 50, the top surface 32 of the pieces 30 must be cleaned to remove excess grout thereon so that grout remains primarily only in the spaces 40 between individual tile pieces 30.

This prior art method unfortunately had a number of drawbacks in that the cutting of the tile 60 could be difficult and could cause individual pieces 30 to chip, fracture and break. Chipping can be a more significant problem with particular types of stones, such as slate, sheeted segments of which easily detach across parallel planes. Angular cutting of the pieces is particularly difficult because, as explained, the flexible nature the netting allows the pieces to move when subject to vibration or nudging.

Further, as explained, the laying of spacers 31 is extremely time consuming. Additionally, the height of the grout 50 within the spaces 40 was difficult to maintain uniform, unless the grout 50 is poured such that it fills the spaces completely. In other words, having grout filled at an intermediate height (i.e. below the level of the surface of the tile pieces 30) between all of the tile pieces 30 can be difficult to achieve uniformly.

A further problem with the traditional method is that smaller dimensional pieces such as ⅜″ could not be easily laid as the height may not be sufficient to create significant contract by the grout between such adjacent pieces.

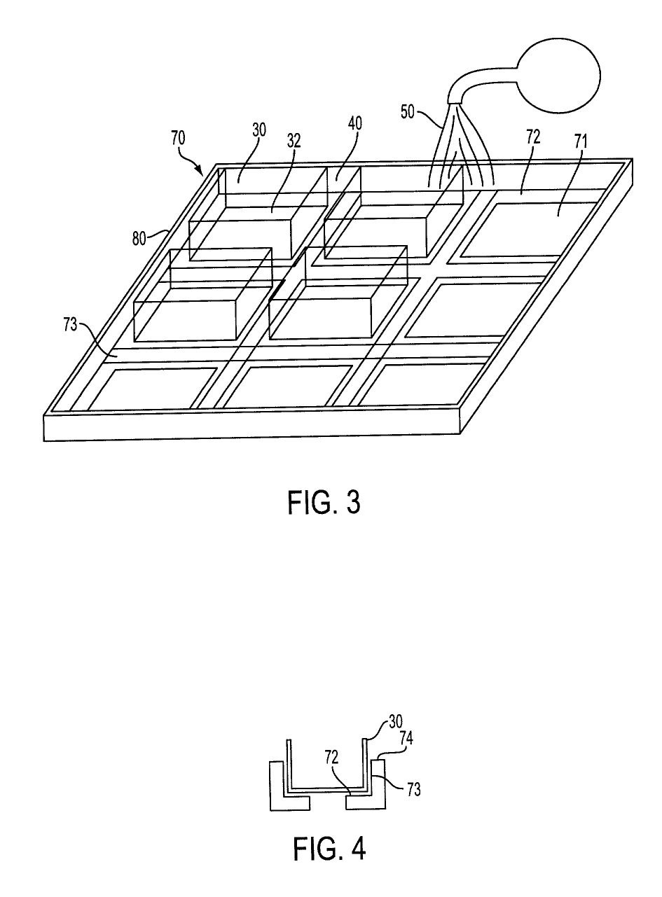

The inventive apparatus and method for creating mosaic structures generally comprises providing a template frame 70 which, in this case, is rectangular, although it may be of any shape. The template frame 70 generally includes a circumferential outer wall 80 and has tile piece positions 71 for individual tile pieces 30. Each position 71 includes a base 72 extending under the pieces 30 (see FIG. 3) so that the pieces do not fall through the frame 70. Individual pieces 30 are also circumscribed by positioned parametric walls 73 which do not extend above the surface or depth of each piece 30.

Once the pieces 30 are inserted into the frame in a respective position, a netting (not shown) may optionally be placed over preferably all of the pieces 30.

Subsequently, grout 120 is poured onto the bottom surfaces 33 of the pieces 30 (which are inserted face down in frame 70) until the grout 120 completely fills the spaces 40 between the individual tiles 30 and covers top planar surfaces 74 of the positional parametric walls 73. Sufficient grout 120 is poured so that not only the spaces 40 between individual tile pieces filled, but also to provide sufficient grout layer thickness covering the bottom surfaces 33 of the tile pieces 30 to hold secure all of the pieces together as a single tile 60 once the tile 60 is removed. The grouting is then allowed to dry and the final product—a solid piece of mosaic tile, is removed from the frame.

This method overcomes many of the problems associated with the traditional method of laying tile. Some of the advantages which overcome problems with the prior art method are:

(1) the level of the grout is uniform and defined by the top planar surfaces 74 of the positional parametric walls 73;

(2) the laying of spacers is eliminated by the existence of the positional parametric walls 73;

(3) since the tile pieces 30 are positioned top side down, the base 72 ensures that the top surfaces of the tile pieces 30 will be relatively flush virtually regardless of the height of individual tile pieces 30;

(4) chipping is reduced as the grouted tiles are formed with a thickness of grout 120 underneath the tile pieces 30; the tiles can thus be easily cut—even at an angle; and

(5) the cost of metal or other punchable pieces are greatly reduced because the invention facilitates the use of “punched,” open ended rectangular shaped metal pieces which can be formed from metal sheets (decreasing substantially the volume of metal necessary over using filled metal pieces).

While the preferred embodiment of the invention has been depicted in detail, modifications and adaptations maybe made thereto without departing from the spirit and scope of the invention as delineated in the following claims:

What is claimed is:

1. A method of creating mosaic structures, said method comprising the steps of:
providing a frame comprising spaces for individual pieces of the structure, each of said spaces comprising a substantially circumscribing wall which is shorter than the thickness of each piece, said wall separates adjacent pieces to create gaps between adjacent of said pieces;
inserting said pieces into at least some of said spaces;
pouring a pasty, flowable adhesive material over the pieces to fill gaps between adjacent pieces;
permitting said material to dry; and
removing resulting mosaic structure from the frame.

2. The method of claim 1, further comprising the step of applying an adhesive on the pieces before pouring the adhesive material.

3. The method of claim 2, further comprising the step of providing a netting material over the applied adhesive before pouring the joint material.

4. An apparatus for creating mosaic structures, said apparatus comprising:
a frame comprising spaces for individual pieces of the structure; and
a substantially circumscribing wall defining the parameters of each of said spaces, wherein said wall is shorter than the thickness of the pieces and separates adjacent pieces to create gaps between the adjacent pieces; and
wherein said pieces are inserted into said spaces;
an adhesive material is poured to fill gaps between adjacent spaces;
permitting the adhesive to dry, and removing the resulting mosaic structure from the frames.
